(19) United States
(12) Patent Application Publication
(10) Pub. No.: US 2016/0142005 A1
(43) Pub. Date: May 19, 2016

(54) THERMOPHOTOVOLTAIC SYSTEM HAVING A SELF-ADJUSTING GAP

(71) Applicant: University of Utah Research Foundation, Salt Lake City, UT (US)

(72) Inventors: Michael Bernardi, Salt Lake City, UT (US); Mathieu Francoeur, Salt Lake City, UT (US)

(21) Appl. No.: 14/941,257

(22) Filed: Nov. 13, 2015

Related U.S. Application Data
(60) Provisional application No. 62/105,455, filed on Jan. 20, 2015.
(60) Provisional application No. 62/080,106, filed on Nov. 14, 2014.

(51) Int. Cl. H02S 10/30; H02S 50/00; H02S 40/40

(52) U.S. Cl. CPC H02S 10/30; H02S 40/40; H02S 50/00

(57) ABSTRACT

A thermophotovoltaic system for generating energy can include a photovoltaic cell, a radiator separated from the photovoltaic cell by a vacuum gap having a distance of less than 10 micrometers, and an actuator operably connected with at least one of the photovoltaic cell and the radiator to adjust the gap distance. A method of thermophotovoltaic energy conversion can include heating a radiator to produce infrared radiation, irradiating a photovoltaic cell with the infrared radiation to produce an electric current, maintaining a vacuum gap between the radiator and the photovoltaic cell with a gap distance of less than 10 micrometers, and dynamically adjusting the gap distance during irradiating based on a temperature of at least one of the radiator and the photovoltaic cell.

### RELATED APPLICATIONS

This application is related to U.S. Provisional Application No. 62/080,106, filed Nov. 14, 2014 and U.S. Provisional Application No. 62/105,455, filed Jan. 20, 2015 which are incorporated herein by reference.

### GOVERNMENT INTEREST

This invention was made with government support under CBET1253577 awarded by the National Science Foundation. The government has certain rights in the invention.

### BACKGROUND

Thermophotovoltaic energy conversion involves converting energy from heat to electricity through the use of photons. Thermophotovoltaic systems generally include a thermal emitter and a photovoltaic cell. The thermal emitter is heated to an elevated temperature, such that the thermal emitter emits photons of infrared or near-infrared radiation. The photovoltaic cell absorbs these photons and produces an electric current.

Solar photovoltaic applications typically use cells with absorption bandgaps of about 1.1 eV (visible band). Because thermophotovoltaic (TPV) radiators operate at lower temperatures, such as 400 K-2000 K, thermal emission occurs mostly in the near infrared (NIR) and infrared bands such that cells with bandgaps lower than 1.1 eV are required. For examples, TPV cells often have bandgaps from about 0.5 eV to 0.75 eV. Some TPV cells are made of III-V binary compounds, such as gallium antimonide (GaSb) and gallium arsenide (GaAs), as well as their ternary and quaternary III-V alloys. TPV systems also often include thermal management systems to keep the temperature of the TPV cell around 300 K.

The efficiency-to-cost ratio of conventional thermophotovoltaic systems is generally lower than other electricity generating technologies. The thermal emitter emits radiation according to Plank's blackbody spectrum. At the relatively low temperatures used in typical thermophotovoltaic systems, the most energetic radiation emitted is infrared or near-infrared radiation. This radiation contains less energy than visible light such as sunlight. Therefore, thermophotovoltaic systems have generally been less useful than solar photovoltaic cells.

### SUMMARY

The present invention provides thermophotovoltaic systems for generating energy and methods of thermophotovoltaic energy conversion. Generally, the invention includes a thermophotovoltaic cell and a heat source separated by a self-adjusting gap on the order of 10 micrometers or less.

In some embodiments, a thermophotovoltaic system for generating energy can include a photovoltaic cell, a radiator separated from the photovoltaic cell by a vacuum gap having a gap distance of less than 10 micrometers, and an actuator operably connected with at least one of the photovoltaic cell and the radiator to adjust the gap distance. In some aspects, the gap distance can be less than 2 micrometers, less than 1 micrometer, or in some cases from 10 nanometers to 1 micrometer.

In one example, the thermophotovoltaic system for generating energy can include a control module in communication with the actuator. The system can also include a temperature sensor in thermal communication with the photovoltaic cell to measure a cell temperature. The control module can be configured to displace the actuator to adjust the gap distance in response to the cell temperature.

In a specific example, the thermophotovoltaic energy conversion system can include a photovoltaic cell, a radiator separated from the photovoltaic cell by a vacuum gap having a gap distance from 10 nanometers to 1 micrometer, and a flexible membrane supporting the radiator such that the radiator is moveable with respect to the photovoltaic cell. The flexible membrane can be supported by a membrane support which holds a portion of the flexible membrane stationary. The membrane support can also be separated from the photovoltaic cell by a spacer so that the membrane support is maintained at a desired target distance from the photovoltaic cell. A plurality of complimentary electrostatic pads and a plurality of complimentary conductive pads can be located on the photovoltaic cell and the radiator. The conductive pads can be used to measure capacitance between the pads to determine distance and/or parallelism between the radiator and the photovoltaic cell. The electrostatic pads can be used to move the radiator in relation to the photovoltaic cell by applying an electric charge across the electrostatic pads. A temperature sensor can also be in thermal communication with the photovoltaic cell to measure a cell temperature. A control module in communication with the electrostatic pads, the temperature sensor, and the conductive pads can be configured to maintain the radiator parallel to the photovoltaic cell and the maintain a variable gap distance that provides increased heat to electric current conversion efficiency based on the temperature measured by the temperature sensor.

In another embodiment of the present invention, a method of thermophotovoltaic energy conversion can include heating a radiator to produce infrared radiation from the radiator. A photovoltaic cell can be irradiated with the infrared radiation to produce an electric current. A vacuum gap with a gap distance of less than 10 micrometers can be maintained between the radiator and the photovoltaic cell. This gap distance can be dynamically adjusted during irradiating based on a temperature of the radiator, the photovoltaic cell, or both.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a cross-sectional side view schematic of a thermophotovoltaic device;

FIG. 2 is a graph of monochromatic radiative flux between two bulks of SiC at different gap distances;

FIG. 3 is a graph showing maximum power output, radiation absorbed by the cell, and the conversion efficiency of a thermophotovoltaic device made of a tungsten radiator and indium gallium antimonide cells;

FIG. 4 is a graph showing heat flux and power generated by a thermophotovoltaic system at various temperatures;

FIG. 5 shows a top-down schematic view of a lower portion of a thermophotovoltaic system in accordance with an embodiment of the present invention;

FIG. 6 shows a bottom-up schematic view of an upper portion of a thermophotovoltaic system in accordance with an embodiment of the present invention;

FIG. 7A shows a cross-sectional side view of a thermophotovoltaic system in accordance with an embodiment of the present invention;

FIG. 7B shows a cross-sectional side view of a thermophotovoltaic system in accordance with an embodiment of the present invention;

FIG. 8 shows a cross-sectional side view of a thermophotovoltaic system in accordance with an embodiment of the present invention;

FIG. 9 shows a side perspective view of a spring-like spacer in accordance with an embodiment of the present invention;

FIG. 10 is a flowchart illustrating one exemplary embodiment of a method of thermophotovoltaic energy conversion; and

FIG. 11 is a graph showing heat rate vs. temperature difference in an embodiment of the present invention.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Definitions

In describing and claiming the present invention, the following terminology will be used.

The singular forms “a,” “an,” and “the” include plural referents unless the context clearly dictates otherwise. Thus, for example, reference to “a spacer” includes reference to one or more of such materials and reference to “applying” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

The present invention is directed towards a thermophotovoltaic system for generating electricity, and a method of thermophotovoltaic energy conversion. In some embodiments, the system and method can allow for maintaining, controlling and self-adjusting a micro- or nano-size gap between a heat source and a photovoltaic cell via a flexible membrane and electrostatic forces for direct thermal to electrical energy conversion.

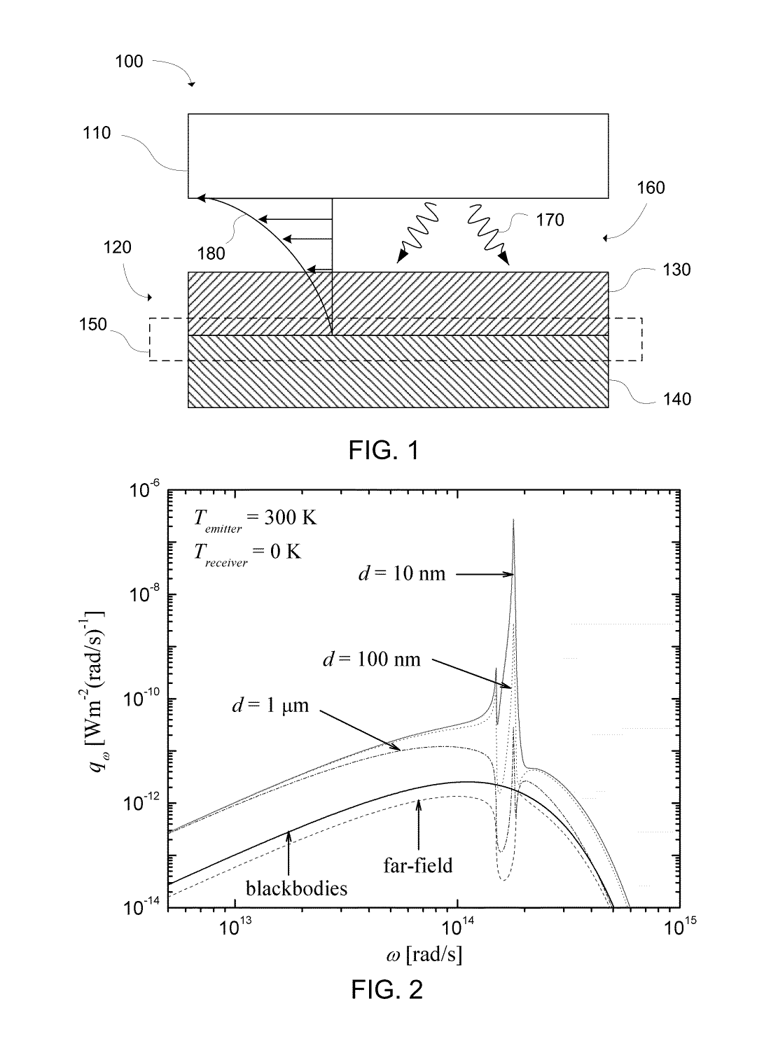

In one embodiment, the system can include a self-contained, self-optimizing, variable gap MEMS-based device, capable of generating electric power by converting thermal radiation emitted by a heat source into electricity via a thermophotovoltaic (TPV) cell. The heat source and the TPV cell can be separated by a vacuum gap of several microns to several nanometers. At this gap distance, due to the contribution of evanescent modes, the radiative heat flux can exceed the blackbody limit by several orders of magnitude. This makes it possible to generate more power than conventional TPV systems limited to the blackbody distribution. This effect is illustrated in FIG. 1. This figure shows a nano-gap thermophotovoltaic device 100 having a radiator 110 and a thermophotovoltaic cell 120. The thermophotovoltaic cell is a photovoltaic cell configured to generate electricity form infrared radiation. The thermophotovoltaic cell includes a p-doped region 130 and an n-doped region 140. A depletion region 150 forms at the P-N junction when photons cause electrons and holes to jump out of the depletion region. The radiator and thermophotovoltaic cell are separated by a vacuum gap 160. The gap distance can be micro- or nano-scale, such as from about 10 micrometers down to about 10 nanometers. The thermophotovoltaic cell receives both propagating modes 170 and evanescent modes 180 of infrared radiation. When the gap distance is small, the amount of heat flux from the infrared radiation can be many times more than the typical blackbody radiation due to the evanescent modes.

The gap distance can be less than a wavelength of the infrared radiation emitted by the radiator. In some examples, the gap distance can be less than a peak blackbody wavelength of the radiator as determined by Wien's law (Equation 1):

λ_{w}T=2898 μm·K (1)

where λ_{w} is the peak wavelength of radiation emitted by the radiator and T is the temperature of the radiator in Kelvins. As an example, a radiator at a temperature of 2000 K would have a peak wavelength of 2898/2000=1.45 micrometers. In order to generate significant power from evanescent modes, the gap distance can be less than the peak wavelength. In some cases, more power can be generated when the gap distance is significantly below the peak wavelength, such as one or two orders of magnitude less than the peak wavelength. In one example, a ratio of the gap distance to the peak wavelength can be from 1:100 to 1:10. In many cases a particular gap distance can provide the optimal efficiency of energy conversion. The optimal gap distance can vary depending on various factors such as temperature of the heat source and the TPV cell.

When a TPV cell is illuminated, the absorption of a wave with an energy E equal or larger than the bandgap E_{g} of the cell generates electron-hole pairs (EHPs). The energy of the wave can be found by Equation 2:

E=h̅ω/e (2)

where h is the reduced Planck constant, ω is the angular frequency and e is the electron charge. EHPs produce a photocurrent if they reach the depletion region formed at the junction of p- and n-doped semiconductors. Radiation with E<E_{g} does not contribute to photocurrent generation, and is dissipated in the form of heat via absorption by the lattice and the free carriers. Additionally, radiation with E>E_{g} releases its excess energy into heat, a phenomenon called thermalization. Non-radiative recombination of EHPs also contributes in raising the cell temperature. While the photocurrent generated by the cell is essentially insensitive to the temperature, the power generated is greatly affected by the thermal effects due to an increase of the dark current with increasing temperature. Heat sources within the cells can be minimized by matching near-field emission and absorption spectra of the radiator and the cells.

In nano-TPV devices, classical tools based on Planck's blackbody distribution do not accurately predict radiative heat transfer. Near-field effects of thermal radiation can be accounted for by solving the Maxwell equations combined with fluctuational electrodynamics, where thermal emission is modeled as fluctuating currents. FIG. 2 is a graph of monochromatic radiative flux q_{ω} (Wm⁻²(rad/s)⁻¹) between two bulk SiC at different gap distances d. Results show a significant enhancement of the flux as the gap d decreases. The resonant peak at a frequency co of 1.786×10¹⁴ rad/s (corresponding to an energy of 0.12 eV and a vacuum wavelength of 10.55 μm) is due to surface phonon-polaritons. For a 10-nm-thick gap, the total heat flux (i.e., integrated over the entire spectrum) is about 1300 times larger than the blackbody predictions.

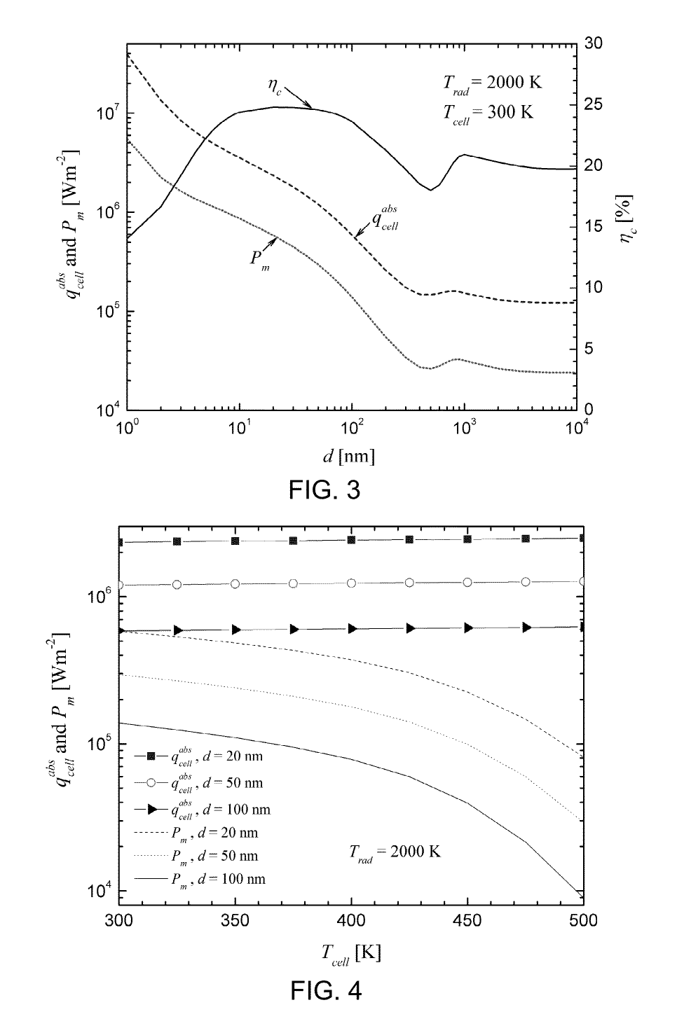

Thus, power generation can be enhanced by using nano-sized gap distances. However, reducing the gap distance can result in tradeoffs in conversion efficiency due to thermal effects in the photovoltaic cell. FIG. 3 is a graph showing maximum power output (Pₘ), the radiation absorbed by the cell (q_{cell}^{abs}), and the conversion efficiency (η_{c}) of a nano-TPV device made of a tungsten radiator and indium gallium antimonide (In_{1.18}Ga_{0.82}Sb) cells (bandgap of 0.56 eV at 300 K). The radiator and the cells are maintained at 2000 K and 300 K, respectively. Results show that the radiation absorbed by the cells and the power output increase as the gap d decreases. For 100-nm-, 20-nm- and 10-nm-thick gaps, power generation is enhanced by a factor of 6, 24 and 36, respectively, compared to large gaps (d>5 μm). However, FIG. 4 is a graph showing that the power generated is quite sensitive to the temperature of the cell, due to an increasing dark current as T_{cell} increases. Solution of the coupled near-field thermal radiation, charge and heat transport model suggests that it is challenging to maintain the cells at room temperature for gaps below 100 nm with a tungsten radiator due to high heat dissipation within the cells. Modeling the thermal management device as a convective boundary, heat transfer coefficients as high as 10⁵ Wm⁻²K⁻¹ can be needed to maintain the cells around 300 K.

For the reasons explained above, in some cases an optimal gap distance can provide the best combination of conversion efficiency, power output, and thermal management requirements. The present invention provides for a variable micro- or nano-size gap between the heat source and the TPV cell that can be adjusted to maintain an optimal gap distance even as the temperatures of the radiator and/or photovoltaic cell change. In one embodiment, this can be accomplished through the use of electrostatic forces balanced by a restoring spring force of a flexible membrane. The ability to control the distance between the heat source and the cell allows for power generation at various gaps without the drawback of fabricating multiple devices or applying an external mechanical force. Additionally, the system can be self-optimizing by adjusting the gap size via a closed-loop feedback system in order to maximize power generation at various source and cell temperatures.

Power generation in a nanoscale-gap thermophotovoltaic (nano-TPV) device can be enhanced by a factor of 20 to 30 compared to conventional TPV systems. A nano-TPV device having a surface of a centimeter square can potentially generate more than 30 Watts of electrical power. Such nano-TPV power generators can be used in the field of waste heat recovery. TPV power generation refers to direct thermal-to-electrical energy conversion of near infrared and infrared radiation emitted by a terrestrial source. Conventional TPV systems are limited by the blackbody spectrum. By separating the radiator and the cells by a nanosize gap, radiation heat transfer can exceed the blackbody predictions by a few orders of magnitude due to energy transport by waves evanescently confined within a distance of about a wavelength normal to the surface of a thermal source. Enhanced energy transfer by evanescent wave tunneling can thus lead to a significant increase of TPV power generation.

With this description in mind, in some embodiments of the present invention, a thermophotovoltaic system for generating energy can include a photovoltaic cell, a radiator separated from the photovoltaic cell by a vacuum gap having a gap distance of less than 10 micrometers, and an actuator operably connected with at least one of the photovoltaic cell and the radiator to adjust the gap distance.

More specifically, in one embodiment the system can include a movable plate and a fixed plate. One plate acts as a high temperature radiator (i.e., heat source or thermal emitter) and the other plate is a TPV cell. Either plate can be movable or fixed, as long as at least one of the plates is moveable. In one particular embodiment, the radiator is movable and the photovoltaic cell is fixed. The movable plate can be held in place by a flexible membrane, and the two plates can be held apart with rigid spacers. Four electrostatic pads can be placed at the corners of both surfaces. When an electric charge is applied to the pads, the resulting electrostatic force can cause the movable plate to move relative to the fixed plate. The membrane can act as a restoring spring force to balance the electrostatic force. Gap size can be measured using three additional sets of conductive pads. Since capacitance is dependent on the distance between the plates, the gap size and parallelism of the plates can be determined by measuring the capacitance between the additional pads. The gap spacing and parallelism can be directly controlled by independently adjusting the voltage at each electrostatic pad.

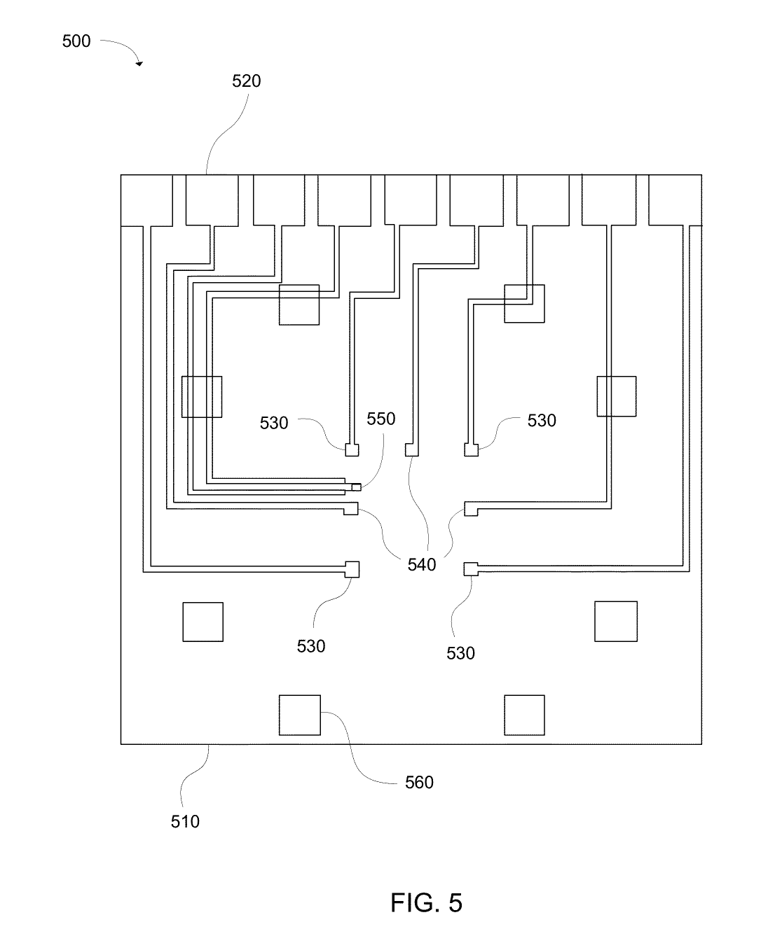

FIG. 5 shows a top-down schematic view of a lower portion 500 of a thermophotovoltaic system in accordance with an embodiment of the present invention. This portion of the thermophotovoltaic system includes a photovoltaic cell 510 with a series of contact pads 520 with connected traces leading to components on the surface of the photovoltaic cell. In this example, four electrostatic pads 530 are connected by traces to four of the contact pads. Three conductive pads 540 are connected by traces to three of the contact pads. A temperature sensor 550 is connected to two of the contact pads. Eight spacers 560 are located on the upper surface of the photovoltaic cell. Typically, the spacers can be non-conductive. The lower portion of the thermophotovoltaic system can be used together with an upper portion, and the spacers can separate the photovoltaic cell from the upper portion.

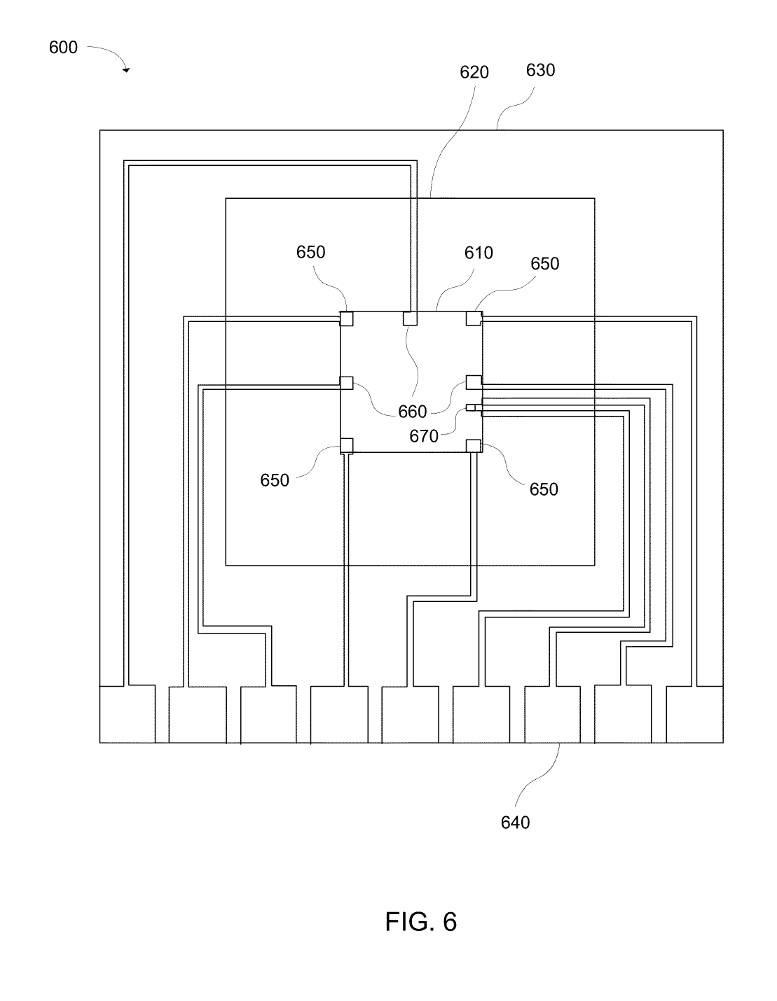

FIG. 6 shows a bottom-up schematic view of an upper portion 600 of the thermophotovoltaic system in accordance with the same embodiment of the present invention as FIG. 5. The upper portion is shown from the bottom up such that if the view of FIG. 6 is flipped horizontally and placed on top of the view shown in FIG. 5, both portions of the thermophotovoltaic system line up so that the electrostatic pads 650 and conductive pads 530 line up in pairs. The upper portion shown in FIG. 6 includes a radiator 610 supported by a flexible membrane 620. The outer edges of the flexible membrane are held stationary by a membrane support 630. The flexible membrane allows the radiator to move closer to or farther from the photovoltaic cell shown in FIG. 5. Similar to the lower portion shown in FIG. 5, the upper portion includes a series of contact pads 640 on the membrane support. Four electrostatic pads 650 are connected by traces to four of the contact pads. Three conductive pads 660 are connected by traces to three of the contact pads. A temperature sensor 670 is connected to two of the contact pads.

The electrostatic pads on the radiator can line up with the electrostatic pads on the photovoltaic cell to form complimentary pairs of electrostatic pads. Electric charge can be applied to these pads to create forces to move the radiator with respect to the photovoltaic cell. For example, opposite charges can be applied to the complimentary pads to create an attractive force between the pads, or similar charges can be applied to the complimentary pads to create a repulsive force between the pads. The flexible membrane supporting the radiator can act as a returning force on the radiator. The returning force can tend to return the radiator to its original position. The complimentary pairs of electrostatic pads and the flexible membrane can work together as an actuator to allow the position of the radiator to be adjusted with fine control.

The additional conductive pads on the photovoltaic cell and radiator can also line up to form complimentary pairs of conductive pads. These complimentary pairs can be used to determine the gap distance and parallelism between the radiator and the photovoltaic cell. This can be accomplished by measuring capacitance across the complimentary pairs. Because capacitance is related to the distance between the pads, the gap distance between each set of complimentary pads can be determined. When multiple complimentary pairs of conductive pads are measured in this way, differences in the distances between the pads can indicate lack or parallelism. The complimentary pairs of electrostatic pads can then be used to adjust the position of the radiator to the appropriate gap distance and to maintain the radiator parallel with the photovoltaic cell.

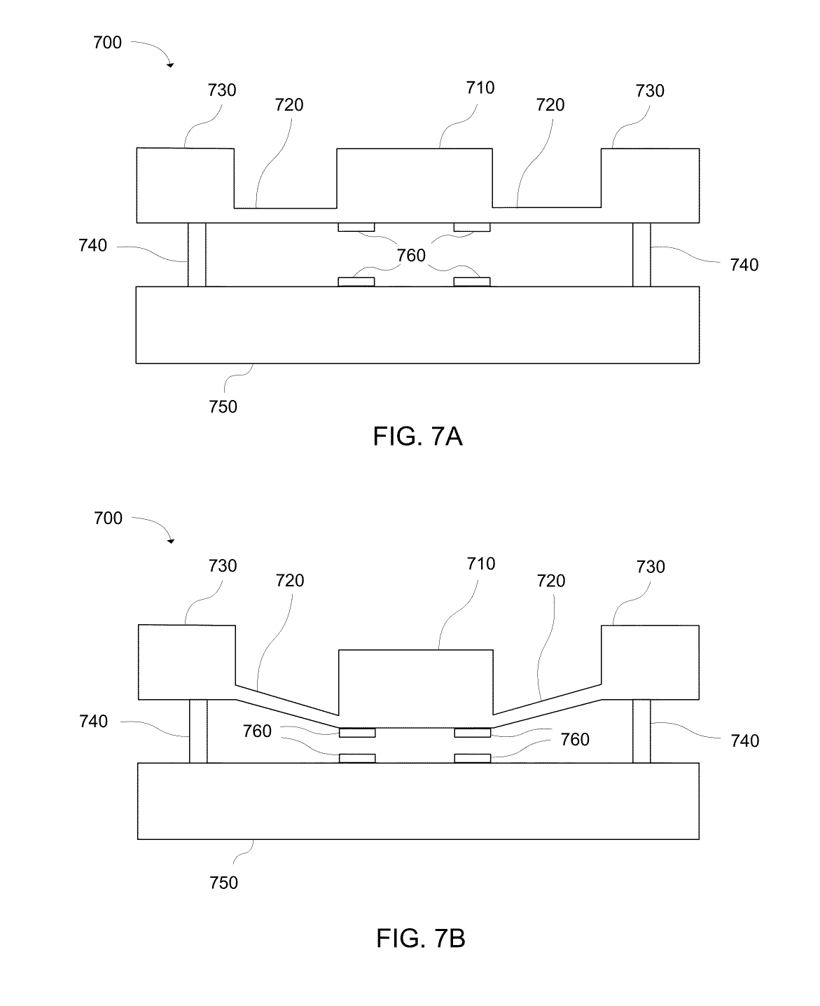

FIG. 7A shows a cross-sectional side view of a thermophotovoltaic system 700 in accordance with an embodiment of the present invention. A radiator 710 is supported by a flexible membrane 720. The outer edges of the flexible membrane are held stationary by a membrane support 730. The membrane support is held on spacers 740, which separate the membrane support from a photovoltaic cell 750. Complimentary pairs of electrostatic pads 760 are positioned on the radiator and the photovoltaic cell.

FIG. 7B shows the thermophotovoltaic system 700 as the electrostatic pads 760 are used to move the radiator 710 closer to the photovoltaic cell 750. The flexible membrane 720 flexes downward to allow the radiator to move with respect to the photovoltaic cell while the outer edges of the flexible membrane are held stationary by the membrane support 730. The membrane support is typically held at a constant distance from the photovoltaic cell by the spacers 740. The flexible membrane can be formed of any resilient flexible material which can be deformed to allow the radiator 710 to vary in position with respect to the photovoltaic cell 750.

Although not shown in the cross-sectional views of FIGS. 7A and 7B, the thermophotovoltaic system can also include conductive pads for measuring capacitance to determine the gap distance and parallelism between the radiator and the photovoltaic cell. The system can also optionally include one or more temperature sensors as described above. It should be noted that although FIG. 7B shows the radiator moving closer to the photovoltaic cell as a result of attractive forces between the electrostatic pads, the radiator can also move away from the photovoltaic cell if like charges are applied to the electrostatic pads to generate repulsive forces between the electrostatic pads.

Furthermore, it should be noted that FIGS. 7A and 7B are not drawn to scale. In thermophotovoltaic systems according to the present invention, the dimensions can be quite different from the dimensions shown in the figures. As described above, the vacuum gap between the radiator and the photovoltaic cell can be from 10 nanometers to 10 micrometers in some examples. In certain examples, the vacuum gap can be adjustable from 10 nanometers to 10 micrometers, while in other examples the vacuum gap can be adjustable within any range encompassed therein. In some cases, the spacers can hold the member support at a fixed distance from the photovoltaic cell. In some examples, the fixed distance between the photovoltaic cell and the membrane support can be from 100 nanometers to 10 micrometers. In further examples, the fixed distance can be from 100 nanometers to 1 micrometer. In alternative examples, flexible spacers can be used that allow the membrane support to move somewhat in relation to the photovoltaic cell. In some examples, the spacers can be formed by spinning on SU-8 photoresist and performing photolithography. Any low thermal conductivity material that is capable of being bonded to both the radiator and TPV cell can be used. For example, glasses, polymers and aerogels can be used.

The electrostatic pads and conductive pads can be formed by evaporating a thin gold layer onto the radiator and TPV cells. Photolithography is then performed in order to create the electrostatic and conductive pads, the traces and contact pads. Any conductive material can be used, such as, but not limited to, metals and highly doped semiconductors. The electrostatic pads and conductive pads can often have a thickness of as little as a few nanometers. In some examples, the electrostatic pads and conductive pads can have a thickness from 1 nm to 50 nm.

The dimensions of the radiator and membrane support are not particularly limited. In some examples, the radiator and membrane support can have about the same thickness. In other examples, the radiator and membrane support can have different thicknesses. In certain examples, the radiator and membrane support can have thicknesses from 1 micrometer to 1 millimeter. In further examples, the radiator and membrane support can have thicknesses from 50 micrometers to 200 micrometers. The length and width of the radiator and membrane support are also not particularly limited. However, in some examples the radiator can have a length and width from about 1 millimeter to about 1 centimeter, and in some cases from about 1 mm to about 10 mm. The radiator and membrane support can be formed by using a monolithic silicon piece and deep reactive ion etching (DRIE) to form the membrane. Alternatively, etching with potassium hydroxide (KOH) can also be used. If the radiator material is different, such as tungsten or silicon carbide, the etching technique and chemistry may change in order to be compatible with the materials being used. For example, hydrogen peroxide and photoelectrochemical etching can be used to etch tungsten and silicon carbide, respectively.

The radiator can be formed from a material that emits radiation that is capable of being absorbed by the photovoltaic cell. In some embodiments, the radiator can be a blackbody emitter. In other embodiments, the radiator can be a material that emits radiation in a spectral distribution optimized for power generation in the photovoltaic cell. This can improve the efficiency of the system by maximizing the energy that is converted to electricity by the photovoltaic cell while limiting additional radiation that only heats up the photovoltaic cell. In one example, the radiator can comprise indium tin oxide and the photovoltaic cell can comprise gallium antimonide. Other non-limiting examples of radiator materials can include tungsten, silicon carbide, silicon, silicon dioxide, silicon nitride, man-made metamaterials and photonic crystals, and the like. In other examples, an optical filter can be placed between the radiator and the photovoltaic cell. The filter can allow radiation matching the bandgap of the photovoltaic cell to pass through while blocking other radiation.

The membrane can be made from a material that has a sufficient flexibility to allow the radiator to move with respect to the photovoltaic cell. In some examples, the membrane can be made from the same material as the radiator and/or the membrane support. For example, the membrane can be made from the same materials as the radiator. It can also be made from polymers such as polymethyl methacrylate (PMMA) and polydimethylsiloxane (PDMS). The membrane can have a thickness that is less than the radiator and membrane support thickness so that the membrane is more flexible. For example, in some cases the membrane can have a thickness from 100 nanometers to 100 micrometers. In one example, the membrane can have a thickness of about 1 micrometer. The membrane can be formed along with the radiator and membrane support. A monolithic silicon piece and deep reactive ion etching (DRIE) can be used to form the membrane. Alternatively, etching with potassium hydroxide (KOH) can also be used. If the radiator material is different, such as tungsten or silicon carbide, the etching technique and chemistry may change in order to be compatible with the materials being used. For example, hydrogen peroxide and photoelectrochemical etching can be used to etch tungsten and silicon carbide, respectively. The membrane can also be formed by casting and then hardening a polymer between the radiator and membrane support.

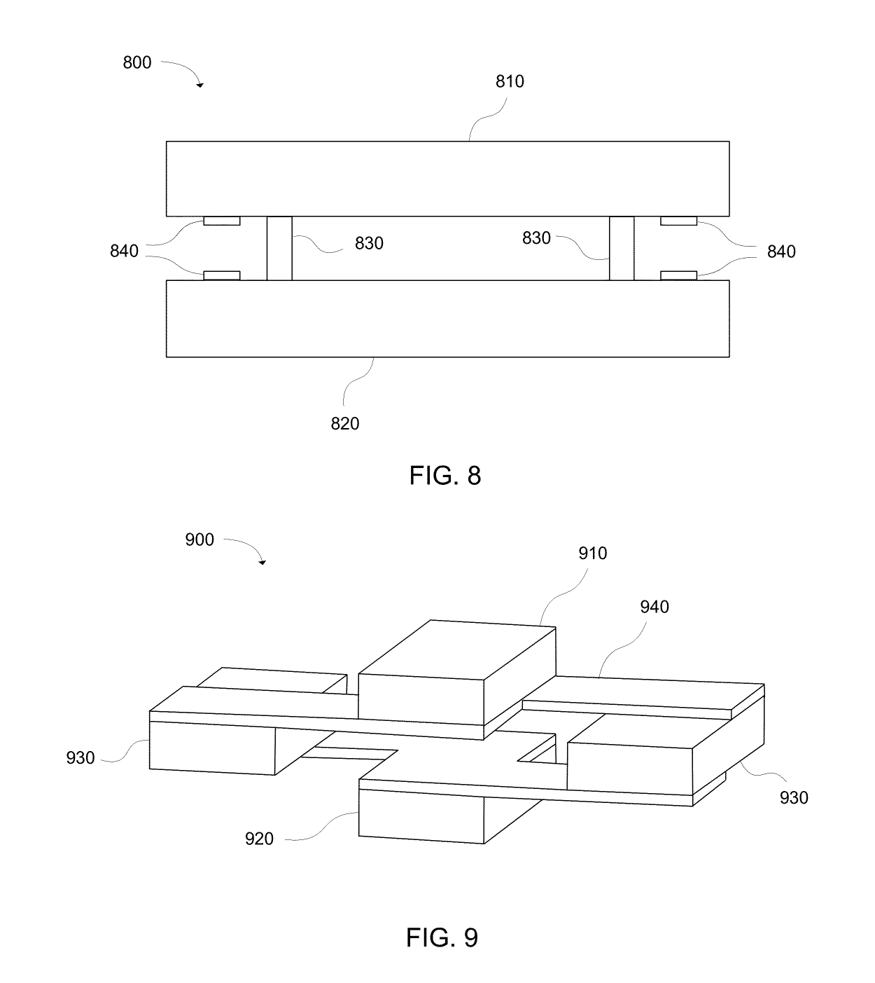

Other embodiments of the present invention can include a thermophotovoltaic system with a radiator that is movable without a flexible membrane. In one example, the radiator can be separated from a photovoltaic cell by flexible, spring-like spacers that allow the radiator to move with respect to the photovoltaic cell. Electrostatic pads can be used to generate attractive or repulsive forces between the radiator and the photovoltaic cell, while the spring-like spacers provide a restoring force tending to return the radiator to its original position. FIG. 8 shows a cross-sectional schematic view of one such thermophotovoltaic system 800. A radiator 810 is separated from a photovoltaic cell 820 by spring-like spacers 830. Electrostatic pads 840 are positioned on the radiator and the photovoltaic cell so that electric charge can be applied to the electrostatic pads to generate attractive or repulsive forces between the pads. These forces can cause the radiator and photovoltaic cell to move closer together or farther apart, while the spring-like spacers exert a restoring force tending to move the radiator and photovoltaic cell back to their original positions. Thus, the gap distance between the radiator and the photovoltaic cell can be adjusted.

A variety of spring-like spacers can be used to separate the radiator from the photovoltaic cell. FIG. 9 shows a perspective view of one example of a spring-like spacer 900 that can be manufactured with a small size to be used in a nano-sized gap in the thermophotovoltaic system. The spring-like spacer can include a top plate 910, bottom plate 920, side plates 930, and flexible arms 940 connecting the top plate and bottom plate to the side plates. This structure can allow the top plate and bottom plate to be moveable with respect to each other. The spring-like spacer can be placed between the radiator and photovoltaic cell in a thermophotovoltaic system. The dimensions of the spring-like spacer are not particularly limited, but the total vertical height of the spring-like spacer can be a suitable height to create any of the gap distances between the radiator and the photovoltaic cell described herein.

In one example, the spring-like spacer shown in FIG. 9 can be made by depositing layers of silicon nitride. The layers of silicon nitride can be deposited using chemical vapor deposition. Photolithography and reactive ion etching can be used to pattern the layers to form the structures of the spring-like spacer. Sacrificial layers of germanium can be deposited as structural supports during the fabrication process. The sacrificial layers can then be removed by xenon difluoride etching. It should be noted that other methods can be used to fabricate spring-like spacers, and the method described here is only one example. Furthermore, the spring-like spacer shown in FIG. 9 is only one example and other forms of spring-like spacers can be used in the thermophotovoltaic systems according to the present invention.

Although the embodiments shown in FIGS. 5-9 have included electrostatic pads and flexible membranes and/or flexible spring-like spacers, the present invention encompasses other embodiments with any type of actuator capable of maintaining and adjusting a gap distance in a thermophotovoltaic system. Other embodiments can include other structures for maintaining and adjusting the gap distance. For example, the gap distance can be adjusted using motors, springs, pistons, piezoelectric materials, bimetallic strips, compressible posts, and so forth. In one embodiment, electrostatic pads can be used to generate an attractive or repulsive force between the plates, and springs can be used to apply a restoring force. In another embodiment, a bimetallic strip can be used to actuate the plates. The bimetallic strip can be formed from two layers of different metals with differing thermal expansion coefficients. When the temperature of the bimetallic strip changes, the bimetallic strip can flex and move the plates closer together or farther apart. In some embodiments, the bimetallic strip can be designed to maintain an optimal gap distance through flexing due to the temperature change of the bimetallic strip.

In many embodiments, the thermophotovoltaic system can include a temperature sensor on one or both of the photovoltaic cell and the radiator. In certain embodiments, the temperature sensor can be an integrated resistance thermometer on one of or both of the radiator and the photovoltaic cell. The resistance of the integrated resistance thermometer changes as temperature varies, allowing for measurement of the temperatures of the radiator and photovoltaic cell. The temperature measured by the temperature sensor can be used to determine an optimal gap distance for the system. Using information from the temperature sensor, the gap distance can be adjusted to the optimal distance. In some examples, the gap distance can be adjusted automatically by a control module in communication with the temperature sensor and the actuator. The control module can receive temperature measurements from the temperature sensor and displace the actuator to adjust the gap distance based on the temperature measurements.

As described above, the power generated by the photovoltaic cell can be a function of the temperature of the photovoltaic cell, the temperature of the radiator, and the gap distance between the photovoltaic cell and the radiator. Therefore, in many cases an optimum gap distance can be found for any given photovoltaic cell and radiator temperatures. In some examples, a correlation between the temperatures, gap distance, and power generation can be determined theoretically. In one example, the optimal gap distance can be calculated using models of near-field thermal radiation, charge transport, and heat transport. This correlation can then be used to control the gap distance to maintain optimal power generation. In other examples, a thermophotovoltaic system can be fabricated and the optimal gap distance can be determined experimentally for various combinations of radiator and photovoltaic cell temperature. Then, a control loop can be used to set the gap distance based on measurements of the radiator and photovoltaic cell temperature while the system is in operation. In further examples, a control module can measure power output of the photovoltaic cell during operation, and use a feedback loop to find an optimum gap distance as the system is in operation. For example, the control module can monitor temperatures, power output and conversion efficiency. Such information can then be used to adjust the gap to maximize power output or conversion efficiency without going above a desired maximum temperature based on material thresholds and performance.

A control module can be in communication with the temperature sensor or sensors, the electrostatic pads, and the conductive pads. The control module can be configured to measure capacitance between the conductive pads to determine the gap distance and parallelism between the radiator and photovoltaic cell. The control module can also receive temperature measurements from the temperature sensor or sensors. Using the information about the temperatures, gap distance and parallelism of the radiator and photovoltaic cell, the control module can automatically apply electric charges to the electrostatic pads to move the radiator with respect to the photovoltaic cell. In one example, the control module can be powered using a portion of the electricity generated by the photovoltaic cell.

As described above, the thermophotovoltaic systems according to the present invention are not limited by Planck's blackbody distribution because a micro- to nano-size gap is maintained between the radiator and the photovoltaic cell. The gap distance separating the radiator and the photovoltaic cell can be easily varied by applying an electric charge to the electrostatic pads embedded within the device. This results in a small size that can be easily integrated into existing technologies. The performance metrics of the device (e.g., power generation, conversion efficiency) are a function of the temperature of the radiator, the temperature of the photovoltaic cell and the gap size. By continually monitoring the surface temperatures, the device can be self-optimizing by adjusting the gap size via a closed loop feedback system.

The system can use any heat source for conversion to electrical energy. The system is versatile due to the self-optimizing gap and can be used, for instance, to recycle low temperature waste heat from electronic devices such as computers and phones, high temperature waste heat from industrial processes, or to convert sunlight into electricity. The system can be used in conjunction with solar photovoltaic cells to convert waste heat from the solar photovoltaic cells into electricity. In some cases, the system can be used to convert body heat from a human body to electricity for charging portable devices. An external power supply is not needed to adjust the gap distance because a small portion of the power generated by the system can be used to maintain the voltage at the electrostatic pads. Typically less than 1% of the power can be used to adjust gap distance. The power used to maintain the gap distance is offset by the additional power generated due to the self-optimizing nature of the device. The power enhancement over traditional TPV systems limited by Planck's law is also likely to offset any increase in manufacturing costs necessary to create the nano- or micro-sized vacuum gap between the two plates.

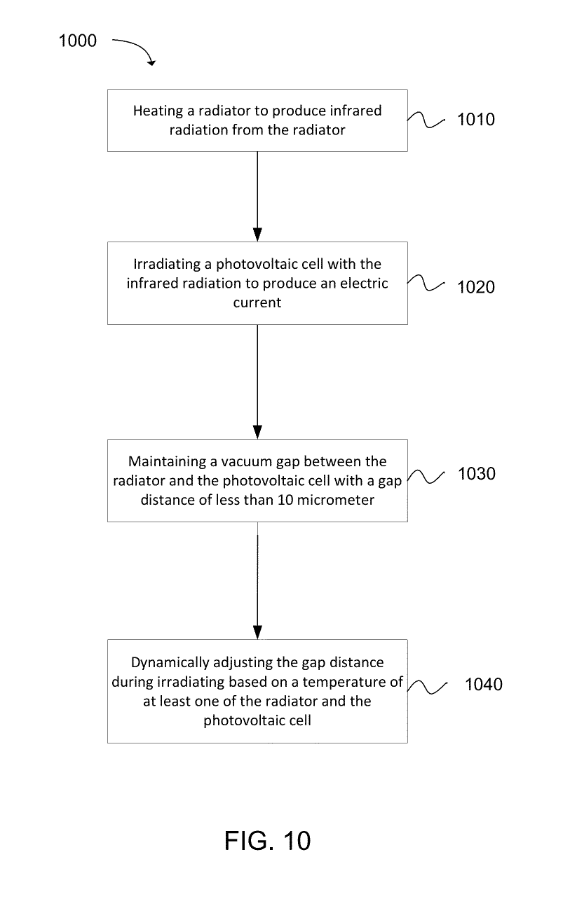

The present invention also encompasses methods of thermophotovoltaic energy conversion. FIG. 10 shows an example of a method of thermophotovoltaic energy conversion 1000. The method can include heating a radiator to produce infrared radiation from the radiator 1010; irradiating a photovoltaic cell with the infrared radiation to produce an electric current 1020; maintaining a vacuum gap between the radiator and the photovoltaic cell with a gap distance of less than 10 micrometers 1030; and dynamically adjusting the gap distance during irradiating based on a temperature of at least one of the radiator and the photovoltaic cell 1040.

A temperature sensor can be used to measure the temperature of at least one of the radiator and the photovoltaic cell. Temperature measurements can be read by a control module in communication with the temperature sensor. The control module can also be in communication with an actuator operably connected with at least one of the photovoltaic cell and the radiator to adjust the gap distance. Thus, the control module can adjust the gap distance in response to the temperature measurements using the actuator.

In some examples, the actuator can include electrostatic pads on the radiator and photovoltaic cell. Adjusting the gap distance can be accomplished by applying an electric charge to the electrostatic pads to generate attractive or repulsive forces between the pads. The actuator can also include a flexible membrane. Adjusting the gap distance can include using the flexible membrane to apply a restorative force to the radiator. In a specific example, adjusting the gap distance can include maintaining a gap distance that provides optimal efficiency of conversion of heat to electric current and electrical power output. The gap distance can be maintained at a distance of less than 10 micrometers. In one example, the gap distance can be maintained at a distance from 10 nanometers to 1 micrometer.

In another specific example, a method of thermophotovoltaic energy conversion can include measuring parallelism of the radiator and the photovoltaic cell, and applying an electric charge across a plurality of electrostatic pads on the radiator and the photovoltaic cell to maintain the radiator parallel to the photovoltaic cell. In another specific example, the parallelism can be measured by measuring capacitance between a plurality of conductive pads on the radiator and the photovoltaic cell.

In further examples of methods of thermophotovoltaic energy conversion, heating the radiator can be accomplished by supplying heat to the radiator from a heat source selected from industrial waste heat, solar energy, waste heat from a solar photovoltaic cell, an electronic device, a human body, an automotive engine, or combinations thereof.

### Example

A thermophotovoltaic system was fabricated to measure heat rate across a gap ranging from 150 nm to 3.5 μm between two silicon surfaces. The device was fabricated from intrinsic silicon. All the conductive features, including the electrostatic actuators and the capacitive pads were fabricated from a layer of evaporated gold. The membrane was fabricated using DRIE. The spacers were made of SU-8 photoresist. The two halves of the device were then aligned and bonded at high temperature and pressure so that the SU-8 posts bonded to both halves of the device.

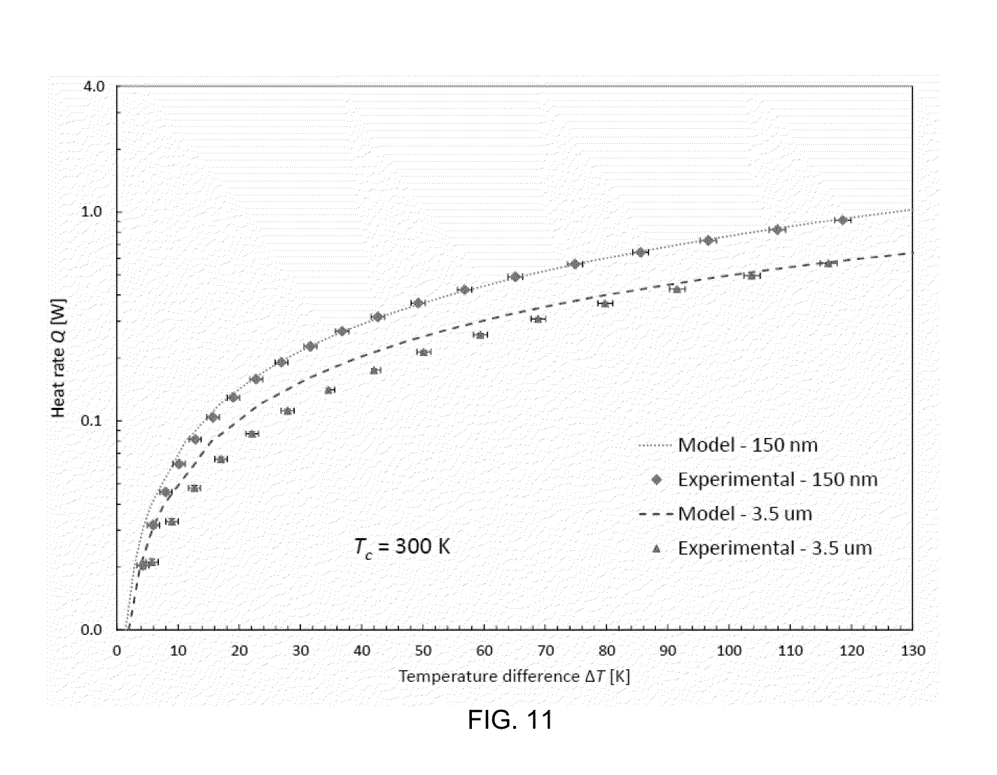

For experimental testing, the radiator was heated using a thermoelectric module acting as a heat pump. An additional thermoelectric module acing as a cooler maintained the cold side of the device at 300 K. All experiments were conducted in vacuum at a pressure of 10⁻⁴ Pa in order to minimize any conduction through air molecules. FIG. 11 shows the heat rate as a function of temperature difference. The experimental data is compared to, and matches well with, predictions. The data collected was for a single device with an adjustable gap. The achieved gap size of 150 nm is the smallest gap ever achieved between flat surfaces by nearly a factor of 3.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A thermophotovoltaic system for generating energy, comprising:
a photovoltaic cell;
a radiator separated from the photovoltaic cell by a vacuum gap having a gap distance of less than 10 micrometers; and
an actuator operably connected with at least one of the photovoltaic cell and the radiator to adjust the gap distance.

2. The system of claim 1, further comprising:
a temperature sensor in thermal communication with the photovoltaic cell to measure a cell temperature; and
a control module in communication with the actuator and the temperature sensor;
wherein the control module is configured to displace the actuator to adjust the gap distance in response to the cell temperature.

3. The system of claim 1, wherein the actuator comprises a first electrostatic pad on the photovoltaic cell and a second electrostatic pad on the radiator, wherein the gap distance is adjustable by applying an electric charge across the first electrostatic pad and the second electrostatic pad.

4. The system of claim 1, wherein the actuator comprises a first plurality of electrostatic pads on the photovoltaic cell and a second plurality of electrostatic pads on the radiator, wherein the gap distance and parallelism of the photovoltaic cell and radiator are adjustable by applying an electric charge across the first plurality of electrostatic pads and the second plurality of electrostatic pads.

5. The system of claim 1, wherein the actuator comprises a flexible membrane supporting the radiator.

6. The system of claim 1, wherein the actuator comprises a compressible spacer separating the radiator from the photovoltaic cell.

7. The system of claim 1, further comprising:
a first conductive pad on the photovoltaic cell;
a second conductive pad on the radiator; and
a capacitance sensor configured to measure capacitance between the first conductive pad and the second conductive pad.

8. The system of claim 1, further comprising a temperature sensor configured to measure the temperature of at least one of the photovoltaic cell and the radiator.

9. The system of claim 8, wherein the temperature sensor is a resistance thermometer integrated into at least one of the photovoltaic cell and the radiator.

10. The system of claim 1, wherein the gap distance is from 10 nanometers to 1 micrometer.

11. A method of thermophotovoltaic energy conversion, comprising:
heating a radiator to produce infrared radiation from the radiator;
irradiating a photovoltaic cell with the infrared radiation to produce an electric current;
maintaining a vacuum gap between the radiator and the photovoltaic cell with a gap distance of less than 10 micrometers; and
dynamically adjusting the gap distance during irradiating based on a temperature of at least one of the radiator and the photovoltaic cell.

12. The method of claim 11, wherein adjusting the gap distance comprises using a temperature sensor to measure the temperature of at least one of the radiator and the photovoltaic cell and using a control module in communication with the temperature sensor and an actuator operably connected with at least one of the photovoltaic cell and the radiator to adjust the gap distance in response to the measured temperature.

13. The method of claim 11, wherein adjusting the gap distance comprises applying an electric charge to an electrostatic pad on at least one of the radiator and the photovoltaic cell.

14. The method of claim 11, wherein adjusting the gap distance comprises applying a restorative force from a flexible membrane supporting the radiator.

15. The method of claim 11, further comprising measuring parallelism of the radiator and the photovoltaic cell, and applying an electric charge across a plurality of electrostatic pads on the radiator and the photovoltaic cell to maintain the radiator parallel to the photovoltaic cell.

16. The method of claim 15, wherein measuring parallelism comprises measuring a capacitance between a plurality of conductive pads on the radiator and the photovoltaic cell.

17. The method of claim 11, wherein heating the radiator comprises supplying heat to the radiator from a heat source selected from the group consisting of industrial waste heat, solar energy, waste heat from a solar photovoltaic cell, an electronic device, a human body, an automotive engine, and combinations thereof.

18. The method of claim 11, wherein adjusting the gap distance comprises maintaining a gap distance that provides optimal efficiency of conversion and electrical power output of heat to electric current.

19. The method of claim 11, wherein the gap distance is maintained from 10 nanometers to 1 micrometer.

20. A thermophotovoltaic energy conversion system, comprising:
a photovoltaic cell;
a radiator separated from the photovoltaic cell by a vacuum gap having a gap distance from 10 nanometers to 1 micrometer;
a flexible membrane supporting the radiator such that the radiator is moveable with respect to the photovoltaic cell;
a membrane support holding a portion of the flexible membrane stationary, the membrane support being separated from the photovoltaic cell by a spacer such that the membrane support is maintained at a fixed distance from the photovoltaic cell;
a plurality of complimentary electrostatic pads on the photovoltaic cell and the radiator;
a temperature sensor in thermal communication with the photovoltaic cell to measure a cell temperature;
a plurality of complimentary conductive pads on the photovoltaic cell and the radiator; and
a control module in communication with the plurality of the electrostatic pads, the temperature sensor, and the plurality of the conductive pads, the control module being configured to measure a capacitance between the plurality of conductive pads and apply an electric charge across the plurality of electrostatic pads to maintain the radiator parallel to the photovoltaic cell and to maintain a variable gap distance that provides an increased heat to electric current conversion efficiency based on the cell temperature measured by the temperature sensor.
